(19) United States
(12) Patent Application Publication
(10) Pub. No.: US 2003/0123562 A1
(43) Pub. Date: Jul. 3, 2003

(54) Adaptive modem, pragmatic decoder and decoding method

(76) Inventors: Eun-A Choi, Chollabuk-do (KR); Dae-ly Chang, Daejeon (KR)

Correspondence Address: JACOBSON HOLMAN PLLC, 400 SEVENTH STREET N.W., SUITE 600, WASHINGTON, DC, 20004, US

(21) Appl. No.: 10/136,524

(22) Filed: May 2, 2002

(30) Foreign Application Priority Data
Dec. 28, 2001 (KR) 2001-86515

(51) Int. Cl. H04L 5/12

(52) U.S. Cl. 375/262; 375/341; 375/329

(57) ABSTRACT

Disclosed is a pragmatic decoder for receiving data encoded by an 8-PSK (phase shift keying) trellis encoder, and using a Viterbi decoder to decode the data, which comprises: an 8-PSK demodulator for demodulating signals transmitted by the trellis encoder; a quantizer for receiving signals from the 8-PSK demodulator, and using a constellation mapping configuration with reference to 0 degrees to detect n constellation position sections; and a soft decision unit for using a constellation position section detected by the quantizer to output a soft decision signal for converting it to I and Q signal arrangements needed for Viterbi decoder inputs.

### BACKGROUND OF THE INVENTION

(a) Field of the Invention

The present invention relates to an adaptive modem, a decoder applied to the adaptive modem, and a decoding method. More specifically, the present invention relates to a pragmatic decoder and decoding method using an 8 phase shift keying (PSK) constellation mapping method.

(b) Description of the Related Art

In the case of using a binary phase shift keying (BPSK) or a quadrature phase shift keying (QPSK) modulation method, a convolutional encoding method is used for error correction, and a Viterbi decoder is utilized to decode the convolutional encoding. Further, a trellis coding method is used for the 8-PSK modulation method, and trellis coded modulation (TCM) of the Ungerboeck decoding method is used to decode the trellis codes.

The Ungerboeck decoding method decodes constellation signals of an 8-PSK demodulator by applying a Viterbi decoding algorithm. However, differing from the Viterbi decoding method of convolutional codes, the Ungerboeck decoding method considers a parallel transition that corresponds to a single branch in the case of calculating branch metric (BM) values. Further, the Ungerboeck decoding method calculates a BM distance between a reference mapping point Ref and a demodulated signal Dmod according to a Euclidean distance from a demodulated signal with reference to a mapping point of data encoded at the time of TCM modulation as expressed in Equation 1, performs a decoding process through a path metric (PM) block and an add compare select (ACS) block, and decodes the decoded received data in the identical manner of the Viterbi decoding algorithm.

BM_{s,k}(i)={square root over ([Re(R_{ef}(i))−Re(D_{mod})]²+[Im(R_{ef}(i))−Im(D_{mod})]²)} Equation 1

In the above equation, in the case a state number is four, “s(=0, 1, 2 and 3)” corresponds to a state node, “k” represents a BM calculation time point, “BM_{s,k}(i)” indicates a BM value of an input branch, and “i(=0, 1, 2 and 3)” shows a branch number.

Since the method for parallel transition and BM calculation and a tracking-back structure of the Ungerboeck TCM decoding method are different from the conventional Viterbi decoder, a (2, 1, m) Viterbi decoder cannot be used, and since it requires square and square root calculation so as to find a Euclidean distance from a received signal at the time of decoding as shown in Equation 1, its hardwired implementation is complex and its decoding requires much time, and accordingly, it is not efficient to implement its hardware.

As a result, when attempting to apply the Ungerboeck TCM decoding method to adaptive modems that support various modulation methods such as BPSK, QPSK, and 8-PSK, its hardware occupies a large space and the corresponding system becomes complex.

Therefore, recent adaptive modem designs use a pragmatic TCM decoding method that allows utilization of the convolutional encoders and Viterbi decoders respectively used for internal decoders in the BPSK and QPSK modulation and demodulation designs, and therefore to support the BPSK, QPSK, and 8-PSK methods altogether, and hence, they reduce space required for hardware and concurrently support various modulation and demodulation methods.

In general, since the Viterbi decoder is used as-is when the pragmatic TCM demodulation method is used, it is required to convert 8-PSK signals to a QPSK format (i.e., an appropriate format to input signals to a Viterbi decoder) before inputting the signals to I and Q channels that are input channels of the Viterbi decoder. In this process, the signals output from the demodulator are input, they are provided on the 8-PSK constellation coordinate, and then quantized to fit to input I and Q channels of the Viterbi decoder.

According to the existing 8-PSK modulator and demodulator design standard, the signals are provided on the constellation coordinate having a reference of 22.5 degrees, and in the case of applying the design method using the constellation coordinate having a reference of 22.5 degrees to the pragmatic PCM decoding method, the performance of the modulator and demodulator is uniformly maintained compared to that of conventional methods, but the performance of an error controller is problematically lowered.

### SUMMARY OF THE INVENTION

It is an object of the present invention to differently apply the TC-8PSK constellation coordinate mapping method to a modulator/demodulator and an error controller so as to achieve improved performance of the error controller.

In one aspect of the present invention, a pragmatic decoder for receiving data encoded by an 8-PSK trellis encoder, and using a Viterbi decoder to decode the data, comprises: an 8-PSK demodulator for demodulating signals transmitted by the trellis encoder; a quantizer for receiving signals from the 8-PSK demodulator, and using a constellation mapping configuration with reference to 0 degrees to detect n constellation position sections; and a soft decision unit for using a constellation position section detected by the quantizer to output a soft decision signal for converting it to I and Q signal arrangements needed for Viterbi decoder inputs.

In another aspect of the present invention, an adaptive modem for supporting various modulation and demodulation methods, comprises: an encoder that comprises: a convolutional encoder for encoding a 1-bit data and outputting encoded 2-bit data; and an 8-PSK modulator for receiving encoded data output from the convolutional encoder and data that are not encoded, and mapping and converting them on 8-state constellations; and a pragmatic decoder that comprises: an 8-PSK demodulator for demodulating signals transmitted by the encoder; a quantizer for receiving signals from the 8-PSK demodulator, and using an 8-state constellation mapping configuration with reference to 0 degrees to detect 8 constellation position sections; and a soft decision unit for using a constellation position section detected by the quantizer to output a soft decision signal for converting it to I and Q signal arrangements needed for Viterbi decoder inputs.

In still another aspect of the present invention, a pragmatic decoder's decoding method comprises: (a) receiving encoded data from an 8-PSK trellis encoder; (b) demodulating the data into an 8-PSK format; (c) receiving the demodulated signals, and using a constellation mapping configuration with reference to 0 degrees to detect 8 constellation position sections; and (d) using the detected constellation position section to output a soft decision signal for converting it to I and Q signal arrangements needed for Viterbi decoder inputs.

### BRIEF DESCRIPTION OF THE DRAWINGS

The accompanying drawings, which are incorporated in and constitute a part of the specification, illustrate an embodiment of the invention, and, together with the description, serve to explain the principles of the invention:

FIG. 1 shows an encoder/decoder according to a preferred embodiment of the present invention;

FIGS. 2(a) and 2(b) show mapped constellation coordinates on the basis of 0 and 22.5 degrees respectively;

FIGS. 3(a) and 3(b) show soft decision allocation for pragmatic TCM decoding with reference to 0 and 22.5 degrees; and

FIG. 4 shows a simulation diagram of a performance curve of the pragmatic TCM decoder according to a constellation coordinate arrangement method.

### DETAILED DESCRIPTION OF THE PREFERRED EMBODIMENTS

In the following detailed description, only the preferred embodiment of the invention has been shown and described, simply by way of illustration of the best mode contemplated by the inventor(s) of carrying out the invention. As will be realized, the invention is capable of modification in various obvious respects, all without departing from the invention. Accordingly, the drawings and description are to be regarded as illustrative in nature, and not restrictive.

FIG. 1 shows an encoder/decoder according to a preferred embodiment of the present invention.

As shown, the encoder 100 comprises a convolutional encoder 110 and an 8-PSK modulator 120; and the decoder 200 comprises an 8-PSK demodulator 210, a quantizer 222, a soft decision unit 224, and a Viterbi decoder 230. The quantizer 222 and the soft decision unit 224 form an error controller 220.

The convolutional encoder 110 has an encoding ratio of ½, and it receives 1-bit data Data 2 to output encoded 2-bit data.

In the preferred embodiment of the present invention, a convolutional encoder having an encoding ratio of ½ is described as an example, and a puncturing encoder can also be used. The 8-PSK modulator 120 receives 1-bit data Data1 that is not encoded and encoded 2-bit data output from the convolutional encoder 110, and maps them to an 8-state constellation diagram. The preferred embodiment of FIG. 1 uses a trellis code of an encoding ratio of ⅔, and in addition, it may also use an encoding ratio of (n−1)/n, where “n” represents a multiple of 3 greater than 2. In this instance, the convolutional encoder 110 performs convolutional encoding on the one-bit data from among (n−1) input bits to output encoded 2-bit data, and the 8-PSK modulator 120 receives the encoded 2-bit data from the convolutional encoder 110 and (n−2) bit data that are not encoded to map them onto a constellation diagram.

According to the embodiment of the present invention, the 8-PSK modulator 120 performs a modulation process using a constellation diagram mapping structure formed with reference to 22.5 degrees, as will be described later.

The 8-PSK modulator 120 receives data from the encoder 100, and modulates them using a constellation diagram mapping structure formed with reference to 22.5 degrees, identical with those of the 8-PSK modulator 120.

The quantizer 222 receives signals from the 8-PSK modulator 120, and uses a constellation diagram mapping structure formed with reference to 0 degrees to detect eight constellation position sections. The soft decision unit 224 uses the eight constellation position sections detected by the quantizer 222, and converts them into I and Q signal arrangements needed for input ends of the Viterbi decoder 230 to output a soft decision signal.

As described above, the modulator 120 and the demodulator 210 use the constellation diagram arrangement algorithm with reference to 22.5 degrees, and the error controllers 222 and 224 use the constellation diagram arrangement algorithm with reference to 0 degrees.

In the below, a design algorithm and corresponding performance of the TC-8PSK constellation arrangements applied to the encoder and the decoder according to the preferred embodiment of the present invention will be described in detail.

1. 8-PSK Encoding

In the TC-8PSK encoder 100 according to the embodiment of the present invention, the QPSK modulator receives 3-bit data, and maps them onto the I (real number) axis and the Q (imaginary number) axis of the 8-PSK modulator 120 in the 8 constellations to modulate them into 8-PSK signals. That is, as expressed in Equation 2, the modulator 120 sets the magnitude of the signal to be \sqrt{2}, and arranges the constellation positions to have identical distances with an identical interval of 45 degrees (that is, π/4) according to encoded data.

S(t)=\sqrt{2}e^{j(2πf}^{₀}^{t+θ}^{ᵢ}⁾ Equation 2

where θᵢ represents a start position of the constellation, and when the start position of the constellation is set to be 0 or 22.5 degrees, the mapping points are provided as the subsequent table. In this table, the start position in the parentheses is provided with reference to 22.5 degrees.

TABLE 1

| Code | Mapping angles | Mapping points | |
|---|---|---|---|
| data | 0° (22.5°) | I | Q |
| 000 | 0 (22.5) | 1.4142 (1.3066) | 0 (0.5412) |
| 001 | 45 (67.5) | 1 (0.5412) | 1 (1.3066) |
| 011 | 90 (112.5) | 0 (-0.5412) | 1.4142 (1.3066) |
| 010 | 135 (157.5) | −1 (−1.3066) | 1 (0.5412) |
| 100 | 180 (205.5) | −1.4142 (−1.3066) | 0 (−0.5412) |
| 101 | 225 (247.5) | −1 (−0.5412) | −1 (−1.3066) |
| 111 | 270 (292.5) | 0 (0.5412) | −1.4142 (−1.3066) |
| 110 | 315 (337.5) | 1 (1.3066) | −1 (−0.5412) |

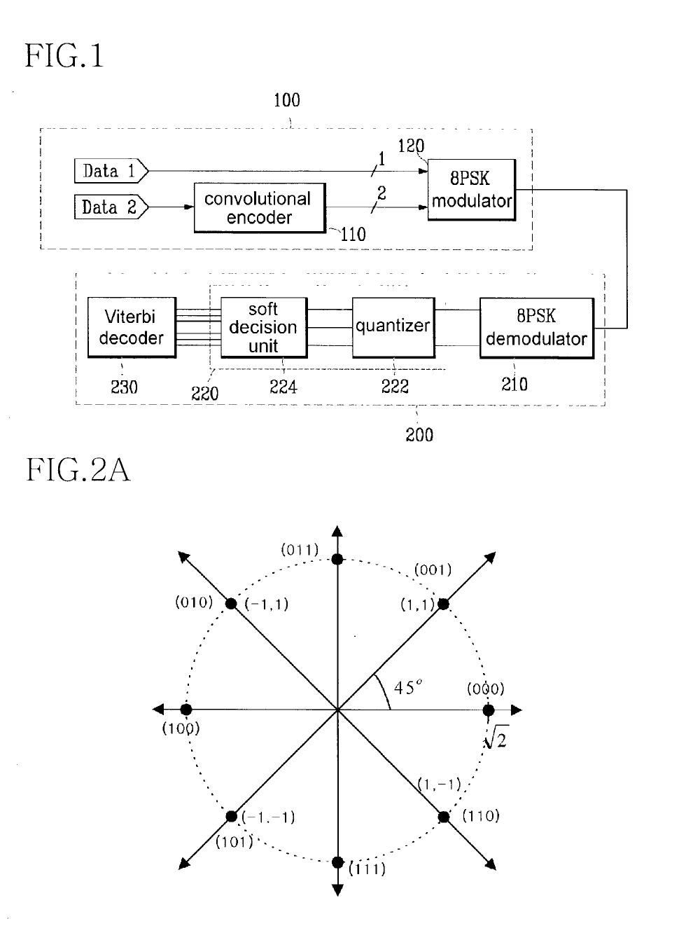

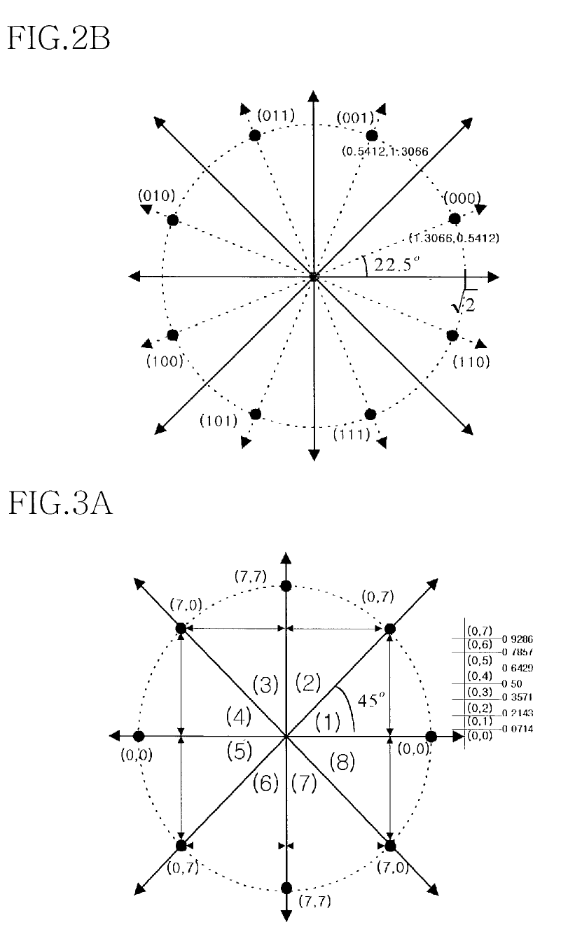

FIGS. 2(a) and 2(b) show the encoded data shown in Table 1 converted into constellations.

2. Pragmatic TCM Decoding

Since the adaptive modulation and demodulation method uses a convolution code and a Viterbi decoder as internal codes for the BPSK and modulations and uses a TCM code for the 8-PSK modulation, it is effective if the same Viterbi decoder is used for the decoding process. Hence, the pragmatic TCM decoding method that can use a (2, 1, m) Viterbi decoder is effective than the Ungerboeck TCM decoding method.

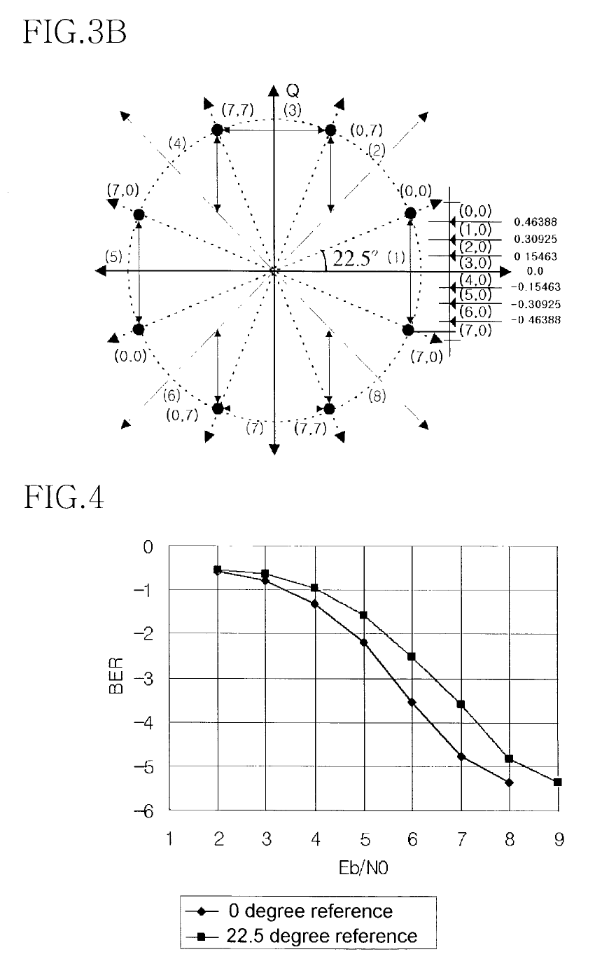

To decode TCM codes using the (2, 1, m) Viterbi decoder, the arrangement of the received 8-PSK signals is to be converted and quantized to that of I and Q QPSK signals. That is, since the 2 and 3 bits are encoded signals in the 8-PSK constellation diagram of FIGS. 2(a) and 2(b), they are to be respectively quantized to I and Q components by the quantizer 222. FIGS. 3(a) and 3(b) show reference mapping points quantized to 3 bits by the 3-bit soft decision unit 224.

2.1 Pragmatic TCM Decoding Method of a Constellation with Reference to 0 Degrees

The decoding method according to the preferred embodiment of the present invention performs a decoding process using a constellation diagram with reference to 0 degrees. That is, eight constellation position sections are detected from the received 8-PSK signals by using the quantizer 222 as shown in the constellation diagram of FIG. 3(a), and they are converted to I and Q signal arrangements needed for the input ends of the Viterbi decoder 230 by using the soft decision unit 224. The (2, 1, m) decoder receives a 3-bit soft decision signal to decode it to one bit.

As a further detailed description of a method for determining soft decision sections and soft decision I and Q values executed by the quantizer 222 and the soft decision unit 224, the quantizer 222 receives a signal containing noise, and compares the I value with the Q value to determine 8 sections, while the soft decision unit 224 performs a soft decision process from the I or Q value according to a determined section as shown in FIG. 3(a). In this instance, in the case of using the constellation diagram with reference to 0 degrees according to the preferred embodiment of the present invention, as shown in FIG. 3(a), all sections are identically provided, absolute values of I and Q are provided between ranges of from 0 to 1, and when the values are quantized to 56 sectors (that is, a 3-bit soft decision), the distance between levels becomes 0.1429.

2.2 Pragmatic TCM Decoding Method of a Constellation with Reference to 22.5 Degrees

As to the decoding method using the constellation diagram with reference to 22.5 degrees, as shown in the constellation diagram of FIG. 3(b), the quantizer 222 receives 8-PSK signals to detect eight constellation position sections, and the soft decision unit 224 arranges the soft-decision-performed values using the I and Q signals according to the detected position sections.

(1) The Case of (1, 3, 5, 7) Section

The sections (1) and (5) determine a soft decision signal level according to an I value of a received signal, and the sections (3) and (7) determine a soft decision signal level according to a Q value of a received signal. A soft decision bit allocation according to a position of a received signal is expressed in Equation 3. Here, “y” represents a level for the soft decision, “n” indicates a soft decision bit number, and “x” shows a soft decision level number having a range of from 1 to (2n−1).

y=2\sqrt{2} sin 22.5÷(2ⁿ−1)×(x−2ⁿ⁻¹) Equation 3

(2) The Case of (2, 4, 6, 8) Section

The (2, 4, 6, 8) section determines a soft decision signal level according to a received signal |Q|, that is, the absolute value of Q, and a soft decision bit allocation according to a position of a received signal is expressed in Equation 4.

y=\sqrt{2} sin 22.5+\sqrt{2}(sin 67.5−sin 22.5)÷(2ₙ−1)×(x−0.5) Equation 4

3. Performance Analysis According to Phase Arrangements

An optimized decoder can be designed by analyzing decoding performance according to the arrangement positions on the constellation diagram. Referring to the constellation arrangement diagrams of FIGS. 3(a) and 3(b), the soft decision distance is 1 in the case of a constellation diagram arranged with reference to 0 degrees, and it is 1.0824 and 0.7654 in the case of a constellation diagram arranged with reference to 22.5 degrees, and hence, the soft decision distance is not constant for each sector. The average soft decision distance of the 22.5-degree constellation diagram is 0.9239 and it is therefore shorter than that (namely, 1) of the 0-degree constellation diagram, which anticipates performance deterioration. Decoding signals with reference to 22.5 degrees generate performance differences of as much as an amount expressed in Equation 5 compared to the decoding signals with reference to 0 degrees.

$${G}_{db} = \frac{1}{2} [ 10 log ( {( 1.0824 / a )}^{2} ) + 10 log ( {( 0.7654 / b )}^{2} ) ] \qquad Equation 5$$

The calculation result of Equation 5 is approximately 0.8 dB, and from Equation 5, it can be anticipated that the performance of the decoding signals having the 22.5-degree reference is reduced by 0.8 dB compared to that of the decoding signals having the 0-degree reference.

FIG. 4 shows simulation results of pragmatic TCM decoding on the 0 and 22.5 reference constellation diagrams, and they have performance differences of about from 0.7 to 0.9 dB.

As described above, while the conventional Ungerboeck TCM decoding method requires a new decoder having a complex hardware configuration, the pragmatic TCM decoding method according to the preferred embodiment of the present invention uses a Viterbi decoder to perform a decoding process, and the hardwired configuration of the decoder can be simplified. Also, in the case of mapping eight constellations of TCM codes onto the I and Q axes, since the decoding of a method starting from 0 degrees maximizes the soft decision distance as described in the preferred embodiment of the present invention, the present invention is anticipated to produce the best performance, and the simulation results show its good receiving performance.

According to the present invention, the TC-8PSK constellation mapping method is differently applied to the modulator/demodulator and the error controller so that the error controller has a simpler decoder configuration and achieves better recovery performance than the conventional TCM decoding method.

While this invention has been described in connection with what is presently considered to be the most practical and preferred embodiment, it is to be understood that the invention is not limited to the disclosed embodiments, but, on the contrary, is intended to cover various modifications and equivalent arrangements included within the spirit and scope of the appended claims.

What is claimed is:

1. A pragmatic decoder for receiving data encoded by an 8-PSK (phase shift keying) trellis encoder, and using a Viterbi decoder to decode the data, comprising:
an 8-PSK demodulator for demodulating signals transmitted by the trellis encoder;
a quantizer for receiving signals from the 8-PSK demodulator, and using a constellation mapping configuration with reference to 0 degrees to detect n constellation position sections; and
a soft decision unit for using a constellation position section detected by the quantizer to output a soft decision signal for converting it to I and Q signal arrangements needed for Viterbi decoder inputs.

2. The pragmatic decoder of claim 1, wherein the 8-PSK demodulator performs a decoding process using a constellation mapping configuration with reference to 22.5 degrees.

3. The pragmatic decoder of claim 1, wherein the constellation position sections are eight sections provided with identical intervals.

4. An adaptive modem for supporting various modulation and demodulation methods, comprising:
an encoder that comprises: a convolutional encoder for encoding a 1-bit data and outputting encoded 2-bit data; and an 8-PSK modulator for receiving encoded data output from the convolutional encoder and data that are not encoded, and mapping and converting them on 8-state constellations; and
a pragmatic decoder that comprises: an 8-PSK demodulator for demodulating signals transmitted by the encoder; a quantizer for receiving signals from the 8-PSK demodulator, and using an 8-state constellation mapping configuration with reference to 0 degrees to detect 8 constellation position sections; and a soft decision unit for using a constellation position section detected by the quantizer to output a soft decision signal for converting it to I and Q signal arrangements needed for Viterbi decoder inputs.

5. The adaptive modem of claim 4, wherein the 8-PSK modulator and the 8-PSK demodulator use a constellation mapping configuration with reference to 22.5 degrees to perform modulation and demodulation.

6. The adaptive modem of claim 4, wherein the encoder has a trellis code's encoding ratio of (n−1)/n where “n” is a multiple of 3 greater than 2, and the convolutional encoder performs convolutional encoding on 1-bit data of among input (n−1) bits to output encoded 2-bit data, and the 8-PSK modulator receives encoded 2-bit data output from the convolutional encoder and (n−2)-bit data that are not encoded, and maps and converts them on 8-state constellations.

7. A pragmatic decoder's decoding method comprising:
(a) receiving encoded data from an 8-PSK trellis encoder;
(b) demodulating the data into an 8-PSK format;
(c) receiving the demodulated signals, and using a constellation mapping configuration with reference to 0 degrees to detect 8 constellation position sections; and
(d) using the detected constellation position section to output a soft decision signal for converting it to I and Q signal arrangements needed for Viterbi decoder inputs.

8. The decoding method of claim 7, wherein in (b) the demodulation process is performed using a constellation mapping configuration with reference to 22.5 degrees.
